(19) United States
(12) Patent Application Publication
(10) Pub. No.: US 2020/0266430 A1
(43) Pub. Date: Aug. 20, 2020

(54) NEGATIVE ELECTRODE ACTIVE MATERIAL, NEGATIVE ELECTRODE, AND BATTERY

(71) Applicant: NIPPON STEEL & SUMITOMO METAL CORPORATION, Tokyo (JP)

(72) Inventors: Sukeyoshi YAMAMOTO, Tokyo (JP); Tatsuo NAGATA, Tokyo (JP); Koji MORIGUCHI, Tokyo (JP)

(21) Appl. No.: 16/305,628

(22) PCT Filed: Jun. 6, 2017
(86) PCT No.: PCT/JP2017/021013

§ 371 Date: Nov. 29, 2018

(30) Foreign Application Priority Data
Jun. 10, 2016 (JP) 2016-116003

(51) Int. Cl. H01M 4/38; H01M 4/505; H01M 4/525; H01M 4/131; H01M 4/134; H01M 10/0525

(52) U.S. Cl. CPC H01M 4/386; H01M 4/505; H01M 4/525; H01M 2004/027; H01M 4/134; H01M 10/0525; H01M 4/131

(57) ABSTRACT

A negative electrode active material is provided that is utilized in a nonaqueous electrolyte secondary battery, and that can improve the capacity per volume and charge-discharge cycle characteristics. The negative electrode active material according to the present embodiment contains an alloy having a chemical composition consisting of, in at %, Sn: 10.0 to 22.5% and Si: 10.5 to 23.0%, with the balance being Cu and impurities. The alloy has at least one type of phase among an η′ phase, an ε phase and a Sn phase in a Cu—Sn binary phase diagram, and the micro-structure of the alloy includes reticulate regions 20, and island-like regions 10 that are surrounded by the reticulate regions 20. The average size of the island-like regions 10 is, in equivalent circular diameter, 900 nm or less.

### TECHNICAL FIELD

The present invention relates to a negative electrode active material, a negative electrode and a battery.

### BACKGROUND ART

Recently, small electronic appliances such as home video cameras, notebook PCs, and smartphones have come into widespread use, and there is a demand to attain a higher capacity and a longer service life of batteries.

Further, due to the widespread use of hybrid vehicles, plug-in hybrid vehicles, and electric vehicles, there is also a demand to make batteries compact.

At present, graphite-based negative electrode active materials are utilized for lithium ion batteries. However, in the case of graphite-based negative electrode active materials, limits exist with respect to lengthening of the service life and compactness.

Accordingly, alloy-based negative electrode active materials that have a higher capacity than graphite-based negative electrode active materials have gained attention. Silicon (Si)-based negative electrode active materials and tin (Sn)-based negative electrode active materials are known as alloy-based negative electrode active materials. Various studies have been conducted on the aforementioned alloy-based negative electrode active materials to realize practical application of lithium ion batteries that have a more compact size and a long service life.

However, an alloy-based negative electrode active material repeatedly undergoes large expansions and contractions at the time of charging/discharging. For that reason, the capacity of the alloy-based negative electrode active material is prone to deteriorate. For example, the volume expansion coefficient of graphite associated with charging is about 12%. In contrast, the volume expansion coefficient of a Si simple substance or a Sn simple substance associated with charging is about 400%. For this reason, if a negative electrode plate of Si simple substance or Sn simple substance is repeatedly subjected to charging and discharging, significant expansion and contraction will occur. In such a case, cracking is caused in a negative electrode compound which is applied on the current collector of the negative electrode plate. Consequently, the capacity of the negative electrode plate rapidly decreases. This is mainly caused by the fact that some of the negative electrode active material peels off due to volumetric expansion and contraction, and as a result the negative electrode plate loses electron conductivity.

International Application Publication No. WO2013/141230 (Patent Literature 1) discloses porous silicon-composite particles having a three-dimensional network structure. It is described in Patent Literature 1 that expansion/contraction changes in the silicon particles can be suppressed by pores in the three-dimensional network structure.

### CITATION LIST

### Patent Literature

Patent Literature 1: International Application Publication No. WO2013/141230

### Non Patent Literature

Non Patent Literature 1: IEEE Transactions on Systems, Man, and Cybernetics, Vol. SMC-8, No. 8, August 1978, Picture Thresholding Using an Iterative Selection Method, T. W. Ridler and S. Calvard

### SUMMARY OF INVENTION

### Technical Problem

However, in Patent Literature 1, as the charge-discharge cycle characteristics of a secondary battery, only a capacity retention ratio up to 50 cycles is shown, and there is a limit to the effect thereof.

It is an objective of the present invention to provide a negative electrode active material which is utilized for nonaqueous electrolyte secondary batteries represented by a lithium ion secondary battery, and which can improve capacity per volume and charge-discharge cycle characteristics.

### Solution to Problem

A negative electrode active material according to the present embodiment contains an alloy having a chemical composition consisting of, in at %, Sn: 10.0 to 22.5% and Si: 10.5 to 23.0%, with the balance being Cu and impurities. The aforementioned alloy has, at least one type of phase among an η′ phase, an ε phase, and a Sn phase in a Cu—Sn binary phase diagram. The micro-structure of the aforementioned alloy has reticulate regions, and island-like regions surrounded by the reticulate regions. The average size of the island-like regions is, in equivalent circular diameter, 900 nm or less.

### Advantageous Effects of Invention

The negative electrode active material according to the present embodiment is capable of improving capacity per volume and charge-discharge cycle characteristics.

### BRIEF DESCRIPTION OF DRAWINGS

FIG. 1 illustrates a Cu—Sn alloy phase equilibrium diagram.

FIG. 2A is a backscattered electron image of the micro-structure of a specific alloy according to the present embodiment which was obtained by SEM observation at a magnification of 100,000 times.

FIG. 2B is a characteristic X-ray image (Sn-M_{ζ} rays) of the micro-structure of a specific alloy according to the present embodiment which was obtained by SEM observation at a magnification of 100,000 times.

FIG. 3 is a view illustrating a production apparatus for producing a specific alloy of the present embodiment.

FIG. 4 is an enlarged view of a region indicated by a dashed line in FIG. 3.

FIG. 5 is a schematic diagram for describing the positional relation between a tundish and a blade member shown in FIG. 3.

FIG. 6 is a view illustrating a powder X-ray diffraction profile and phase identification results of a Test No. 2A.

### DESCRIPTION OF EMBODIMENTS

The negative electrode active material according to the present embodiment contains an alloy having a chemical composition consisting of, in at %, Sn: 10.0 to 22.5% and Si: 10.5 to 23.0%, with the balance being Cu and impurities. The aforementioned alloy has at least one type of phase among the η′ phase, s phase and Sn phase in a Cu—Sn binary phase diagram. Further, another phase that has Cu and Si as main components may also be included.

The micro-structure of the aforementioned alloy has reticulate regions, and island-like regions that are surrounded by the reticulate regions. The average size of the island-like regions is, in equivalent circular diameter, 900 nm or less. In this case, the occurrence of interfacial strain due to differences between phases with respect to the expansion/contraction rate caused by storage of lithium ions is suppressed. Therefore, disintegration of active material particles during the course of charging and discharging is suppressed. As a result, it is easy to obtain an excellent capacity retention ratio and excellent cycle characteristics.

In the present description, a “negative electrode active material” is preferably a negative electrode active material for a nonaqueous electrolyte secondary battery.

The aforementioned chemical composition may further contain, in place of a part of Cu, one or more types of element selected from a group consisting of Ti, V, Cr, Mn, Fe, Co, Ni, Zn, Al, B and C.

The aforementioned chemical composition may contain one or more types of element selected from a group consisting of Ti: 2.0% or less, V: 2.0% or less, Cr: 2.0% or less, Mn: 2.0% or less, Fe: 2.0% or less, Co: 2.0% or less, Ni: 3.0% or less, Zn: 3.0% or less, Al: 3.0% or less, B: 2.0% or less and C: 2.0% or less.

The aforementioned alloy is, for example, alloy particles in which a mean particle diameter is, in terms of the median diameter (D50), in a range of 0.1 to 45 μm. If the mean particle diameter (D50) of the alloy particles is 0.1 μm or more, the specific surface area of the alloy particles is sufficiently small. In this case, because it is difficult for the alloy particles to oxidize, the initial efficiency increases. On the other hand, if the mean particle diameter (D50) of the alloy particles is not more than 45 μm, the reaction area of the alloy particles increases. In addition, it is easy for lithium to be stored as far as the inside of the alloy particles and to be discharged therefrom. Therefore, it is easy to obtain sufficient discharge capacity.

The negative electrode according to the present embodiment contains the negative electrode active material described above. A battery of the present embodiment includes the negative electrode described above.

Hereunder, the negative electrode active material according to the present embodiment will be described in detail. The symbol “%” in relation to an element means “at %” unless specifically stated otherwise.

[Negative Electrode Active Material]

The negative electrode active material of the present embodiment contains a specified alloy (hereunder, referred to as “specific alloy”). The chemical composition of the specific alloy consists Sn: 10.0 to 22.5% and Si: 10.5 to 23.0%, with the balance being Cu and impurities.

Sn: 10.0 to 22.5%

If the Sn (tin) content is too low, the discharge capacity will decrease. On the other hand, if the Sn content is too high, the capacity retention ratio will decrease. Therefore, the Sn content is set in a range of 10.0 to 22.5%. A preferable lower limit of the Sn content is 11.0%, and more preferably is 12.0%. A preferable upper limit of the Sn content is 21.5%, and more preferably is 20.5%.

Si: 10.5 to 23.0%

If the Si (silicon) content is too low, the charge-discharge cycle characteristics will deteriorate. On the other hand, if the Si content is too high, the capacity retention ratio will decrease. Therefore, a preferable lower limit of the Si content is 11.0%, and more preferably is 11.5%. A preferable upper limit of the Si content is 22.0%, and more preferably is 21.0%.

Preferably, the specific alloy is the main component (main phase) of the negative electrode active material. Here, the term “main component” means that the volume ratio of the specific alloy in the negative electrode active material is not less than 50%. The specific alloy may contain impurities within a range that does not cause a deviation from the gist of the present invention. However, it is preferable that the impurities are as few as possible.

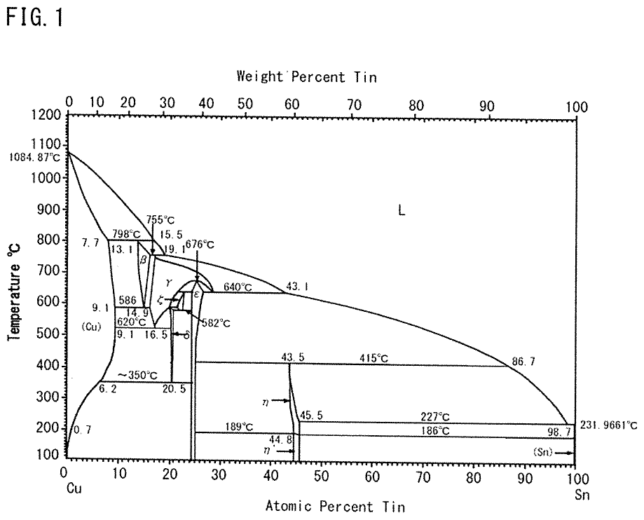

The negative electrode active material according to the present embodiment occludes metal ions (lithium ions and the like). The specific alloy has at least one type of phase among the η′ phase, ε phase and Sn phase, in the Cu—Sn binary phase diagram illustrated in FIG. 1 prior to occlusion of lithium ions. The specific alloy may include phases other than the η′ phase, ε phase and Sn phase. Phases other than the η phase, a phase and Sn phase are, for example, phases having Cu and Si as main components. The specific alloy preferably has a compound phase including two or more types of phase selected from a group consisting of the η phase, ε phase and Sn phase. The term “compound phase” refers to a phase composed of two or more types of different phases. In a case where the one or more types of phase selected from the group consisting of the η′ phase, ε phase and Sn phase is one type of phase, the specific alloy includes a phase other than the η′ phase, ε phase and Sn phase. If a compound phase is formed, the micro-structure will be refined. If the micro-structure is refined, the cycle characteristics improve. Although the reason for this is not certain, it is considered that the reason is as follows.

Each phase of the specific alloy repeats expansion and contraction accompanying charging and discharging. Due to rapid volumetric changes of each phase, in some cases a part of the phase may separate or disintegrate. If the micro-structure is refined, interfacial strain caused by differences between phases in the expansion/contraction rates due to storage of lithium can be alleviated. Therefore, disintegration of the specific alloy can be suppressed, and the cycle characteristics improve. In some cases, in a single phase of any one type among the η′ phase, ε phase and Sn phase, the micro-structure is not refined and the cycle characteristics deteriorate.

The η′ phase and ε phase are equilibrium stable phases at room temperature. Each of the η′ phase and the ε phase form a storage site and a diffusion site of metal ions in the negative electrode active material. Therefore, the volumetric discharge capacity and the cycle characteristics of the negative electrode active material are further improved. Hereunder, in the present description, the η′ phase, ε phase and Sn phase that occlude lithium ions, and an alloy phase after occlusion (occlusion phase) are also referred to together as “specific alloy phases”.

In the present embodiment, these specific alloy phases can be formed in a fine micro-structure form by a rapid solidification process that is described later.

[Method for Analyzing Crystal Structure of Specific Alloy]

Identification of phases contained (also including a case where the specific alloy is contained) in the negative electrode active material can be performed based on an X-ray diffraction profile obtained using an X-ray diffraction apparatus. Specifically, the phases are identified by the following methods.

(1) The negative electrode active material prior to being used for a negative electrode is subjected to an X-ray diffraction measurement for a negative electrode active material to thereby obtain measured data of an X-ray diffraction profile. Phases are identified based on the obtained X-ray diffraction profile (measured data).

(2) For the crystal structure of a negative electrode active material in a negative electrode before charging in a battery, the phases are identified by the same method as that in (1). Specifically, the battery, which is in an uncharged state, is disassembled within a glove box in argon atmosphere, and the negative electrode is taken out from the battery. The negative electrode that was taken out is enclosed with Mylar foil. Thereafter, the circumference of the Mylar foil is sealed using a thermocompression bonding machine. The negative electrode that is sealed by the Mylar foil is then taken out from the glove box.

Next, a measurement sample is fabricated by bonding the negative electrode to a reflection-free sample plate (a plate of a silicon single crystal which is cut out such that a specific crystal plane is parallel with the measurement plane) with hair spray. The measurement sample is mounted onto the X-ray diffraction apparatus, and X-ray diffraction measurement of the measurement sample is performed to obtain an X-ray diffraction profile. Based on the obtained X-ray diffraction profile, the phases of the negative electrode active material in the negative electrode are identified.

(3) X-ray diffraction profiles of the negative electrode active material in the negative electrode after charging one to multiple times and after discharging one to multiple times are also measured by the same method as in (2), and peak locations of an essential diffraction line of the negative electrode active material during charging and the phases during discharging are identified.

Specifically, the battery is fully charged in a charging/discharging test apparatus. The fully charged battery is disassembled in a glove box, and a measurement sample is fabricated by a similar method to that of (2). The measurement sample is mounted onto the X-ray diffraction apparatus and X-ray diffraction measurement is performed.

Further, the battery is fully discharged, and the fully discharged battery is disassembled in the glove box and a measurement sample is fabricated by a similar method to that of (2) to perform X-ray diffraction measurement.

With respect to an X-ray diffraction measurement for analyzing crystal structure changes accompanying charging and discharging, measurement can also be performed by the following method. A coin battery before charging or before and after charging and discharging is disassembled in an inert atmosphere such as argon, and an active material mixture (negative electrode active material) that is coated on the electrode plate of the negative electrode is peeled off from over a current collector foil using a spatula or the like. The negative electrode active material that is peeled off is loaded into an X-ray diffraction sample holder. By using a dedicated attachment which is capable of sealing the negative electrode active material in an inert gas atmosphere, it is possible to perform X-ray diffraction measurement in an inert gas atmosphere even in a state in which the negative electrode active material is mounted on an X-ray diffraction apparatus. By this means, while eliminating the influence of an oxidative action in the atmosphere, X-ray diffraction profiles can be measured from different states of the crystal structure before and after charging and discharging of the negative electrode active material. According to this method, because diffraction lines deriving from the copper foil of the current collector and the like are eliminated, from the viewpoint of the analysis there is the advantage that it is easy to distinguish diffraction lines deriving from the active material.

[Micro-Structure of Specific Alloy: Reticulate Regions and Island-Like Regions]

In order to diffuse and store lithium, preferably the micro-structure of the specific alloy is as fine as possible. In the aforementioned specific alloy, the micro-structure has reticulate regions and island-like regions surrounded by the reticulate regions. Therefore, interfacial strain caused by differences between phases with respect to the expansion/contraction rate due to storage of lithium can be alleviated. Thus, disintegration of the specific alloy can be suppressed and the cycle characteristics improve.

In the aforementioned Cu—Sn binary phase diagram, the 7′ phase and the c phase can be present in both the reticulate regions and the island-like regions.

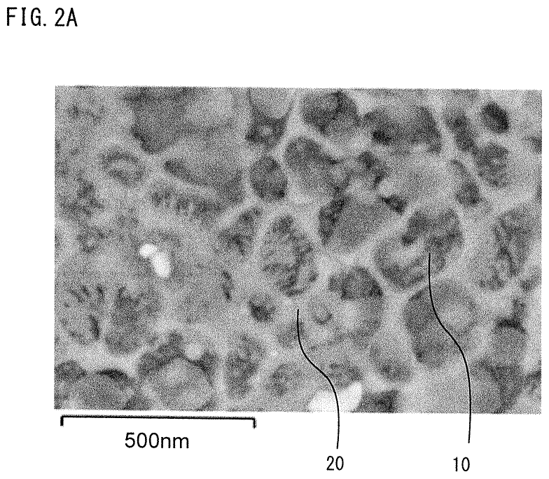

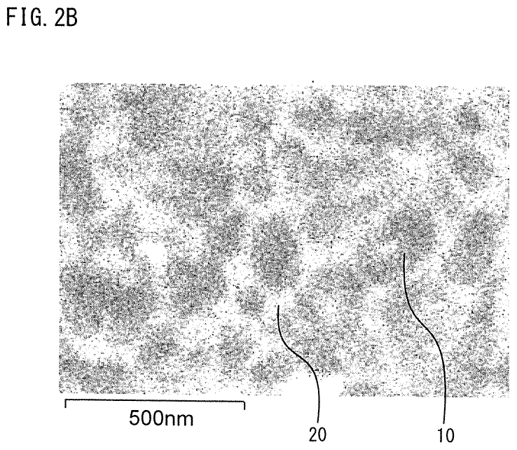

FIG. 2A is a backscattered electron image of the micro-structure of the specific alloy according to the present embodiment which was obtained by SEM observation at a magnification of 100,000 times. Referring to FIG. 2A, black portions are island-like regions 10. White portions in FIG. 2A are reticulate regions 20.

FIG. 2B is a characteristic X-ray image (Sn-Me rays) of the micro-structure of the specific alloy according to the present embodiment which was obtained by SEM observation at a magnification of 100,000 times. In the aforementioned characteristic X-ray image, the greater that the Sn content in a region is relatively, the brighter the relevant region appears in the image. In the aforementioned characteristic X-ray image, the smaller that the Sn content in a region is relatively, the darker the relevant region appears in the image. Note that, the characteristic X-ray image is obtained by mapping the intensity of energy regions of Sn-M_{ζ} rays by means of an energy-dispersive X-ray spectrometer during SEM observation that is described later.

Comparing FIG. 2A and FIG. 2B, it is found that the Sn content is small in the island-like regions 10 in comparison to the reticulate regions 20. Comparing FIG. 2A and FIG. 2B, it is found that the Sn content is large in the reticulate regions 20 in comparison to the island-like regions 10.

[Average Size of Island-Like Regions 10: Equivalent Circular Diameter of 900 Nm or Less]

If the average size of the island-like regions 10 is, in equivalent circular diameter, 900 nm or less, the cycle characteristics increase. Although the reason for this is not certain, it is considered that the reason is as follows. When the micro-structure is reticulate, the reticulate regions 20 enclose phases that repeat charging and discharging, and suppress volumetric changes (expansion and contraction) of the charging and discharging phases. Therefore, the occurrence of a situation in which, due to rapid volumetric changes of a phase that repeats charging and discharging, a part of the phase that repeats charging and discharging separates or disintegrates is suppressed. As a result, the cycle characteristics improve.

If the average size of the island-like regions 10 is more than 900 nm as expressed in equivalent circular diameter, differences arise between phases with respect to the expansion/contraction rate due to storage of lithium. Consequently, strain arises at interfaces, and disintegration of active material particles is promoted during the course of charging and discharging. Therefore, the average size of the island-like regions 10 is made, in equivalent circular diameter, 900 nm or less. A preferable upper limit of the size of the island-like regions 10 is 700 nm or less, and more preferably is 500 nm or less. Although it is preferable for the micro-structure to be as fine as possible, in terms of the production process, it is not easy to make the size of the island-like regions 10 less than 10 nm.

In the present embodiment, the average size of the island-like regions 10 can be made 900 nm or less by a rapid solidification process that is described later.

[Method for Measuring Average Size of Island-Like Regions 10 in Micro-Structure]

The average size of the island-like regions 10 in the micro-structure of the specific alloy in the present description can be measured by the following method.

A test specimen having a vertical cross-section is extracted from the surface of a specific alloy that was subjected to rapid solidification by a production method that is described later. The extracted test specimen is embedded in a conductive resin, and the cross-section (observation surface) is mirror-polished. An arbitrary three visual fields of the observation surface are photographed using a scanning electron microscope (SEM) to create an SEM image (backscattered electron image). The size of each visual field is set as 1.8 μm×2.5 μm.

In the present embodiment, the backscattered electron image was obtained at an accelerating voltage of 5 kV using an SEM SU 9000 (product model number) manufactured by Hitachi High-Technologies Corporation. If the accelerating voltage is too high, the penetration depth of the electron beam from the sample surface will exceed the size level of the micro-structure. Consequently, reflection electron information generated from a position that is deeper than the size of the micro-structure will contribute to image-formation. As a result, in many cases it will not be possible to observe a clear micro-structure form. On the other hand, if the accelerating voltage is too low, a contaminated state of the sample surface will be observed. As a result, in many cases it will not be possible to observe the original form of the micro-structure.

Next, the micro-structure form is measured by image processing. A method for capturing an image and performing image processing will be described next. When capturing an image for image processing, the brightness and contrast are adjusted. The observed micro-structure is saved in an electronic file in bitmap format or JPEG format. In this case, using a gray scale with 255 gradations between white and black (zero corresponds to black, and 255 corresponds to white), it is preferable that the histogram is close to the form of a normal distribution, or that at least color tones in a range of 50 to 150 are included in any of the pixels in the electronic image. The resolution of the image is preferably set to a number of pixels of around 1280×960 with regard to the vertical and horizontal directions. Naturally, the shape of the pixels is quadrate with respect to real space.

Using the micro-structure form that was captured, the average size of the island-like regions 10 surrounded by the reticulate regions 20 is determined by performing an equivalent circular diameter conversion using image processing software. Although an example will be described in which ImageJ Ver. 1.43U (software name) is used as the image processing software, another image processing software may be used as long as a similar result is obtained. The specific procedures are as follows.

(1) The electronic file of the backscattered electron image that is the analysis object is read into the image processing software ImageJ.

(2) Reduction scale information (scale) is set for the backscattered electron image that was read in.

(3) The contrast of the image is adjusted. In this case, on the menu bar, “Image”-“Adjust”-“Brightness/Contrast” are opened, and an operation to make the setting is performed in the order “Auto”-“Apply”-“Set”. By this means, a gray scale histogram in the image can be extended over the entire region of the gradations from 0 to 255, and higher accuracy can be applied to the analysis thereafter.

(4) A threshold value is set, and the image is binarized. To prevent intentional manipulation, an “automatic” adjustment function of the image processing software ImageJ is used to decide the threshold value. In this case, on the menu bar, “Image”-“Adjust”-“Threshold” are opened, and an operation to make the setting is performed in the order “Auto”-“Apply”-“Set”. By this means, a state is entered in which, within the reticulate micro-structure form, the micro-structure (island-like regions 10) corresponding to dark color tones distributed on the inner sides of the reticulate structures are binarized and displayed in color, and the micro-structure of the reticulate regions 20 is displayed in white.

Note that, the image processing software ImageJ has a plurality of kinds of automatic binarization functions. In the present embodiment, “Default” is selected as the binarization method. An “iterative intermeans” method is used as the binarization method according to the “Default” option of the image processing software ImageJ. The “iterative intermeans” method is a method in which the “IsoData Algorithm” is partly modified and changed. The detailed theory regarding the “IsoData Algorithm” is described in IEEE Transactions on Systems, Man, and Cybernetics, Vol. SMC-8, No. 8, August 1978, Picture Thresholding Using an Iterative Selection Method, T. W. Ridler and S. Calvard (Non Patent Literature 1).

More specifically, according to “iterative intermeans”, the respective pixels are binarized into white and black with respect to a threshold value that is an initial setting. The average value of all the binarized pixels is calculated, and it is determined whether or not the average value is lower than the threshold value that is the initial setting. If the average value of all the pixels is lower than the threshold value that is the initial setting, the threshold value that is the initial setting is gradually raised and a similar calculation is performed. This calculation step is repeated until the average value of all the pixels and the threshold value that is the initial setting become equal. The final threshold value obtained by this means is adopted as the threshold value in the present embodiment.

(5) Noise is reduced, and boundaries between the reticulate regions 20 and the island-like regions 10 are clarified. More specifically, pixels are reset based on the median when pixel values within the regions are arranged in size order. In the menu bar, “Process”-“Filters”-“Median” are opened, and “Radius” is set to an appropriate value in a range of 1 to 10 pixels. Normally, by setting “Radius” in a range of 3 to 5, boundaries between the reticulate regions 20 and the island-like regions 10 surrounded by the reticulate regions 20 can be clarified, and analysis of the micro-structure form is facilitated.

(6) Particle analysis is performed, and statistical information regarding the number and area of the island-like regions 10 is determined. In the menu bar, “Analyze”-“Analyze Particles” are opened, the settings below are made, and “OK” is clicked to execute the analysis.

Size (pixel\ddot{ }2): 0-Infinity

Circularity: 0.00-1.00

By this means, statistical information regarding the number and area of the island-like regions 10 surrounded by the reticulate regions 20 is obtained.

(7) After converting all of the obtained area information to equivalent circular diameters, the weighted average value is determined. The thus-determined value is adopted as the average size of the island-like regions 10 that are surrounded by the reticulate regions 20. Note that, the weighted average value determined from the image in FIG. 2A was 276 nm.

(8) When determining the average equivalent circular diameter, from a statistical viewpoint it is desirable that the number of the island-like regions 10 that correspond to a dark color tone which are surrounded by the reticulate regions 20 is 200 or more. In a case where the aforementioned number is less than 200, analysis is performed after increasing the number of observation visual fields.

[Regarding Optional Elements]

As long as the aforementioned specific alloy can have at least one type of phase among the η′ phase, ε phase and Sn phase, the chemical composition of the specific alloy may contain one or more types of element selected from a group consisting of Ti, V, Cr, Mn, Fe, Co, Ni, Zn, Al, B and C in place of a part of Cu.

Preferably, the aforementioned chemical composition contains one or more types of element selected from a group consisting of Ti: 2.0% or less, V: 2.0% or less, Cr: 2.0% or less, Mn: 2.0% or less, Fe: 2.0% or less, Co: 2.0% or less, Ni: 3.0% or less, Zn: 3.0% or less, Al: 3.0% or less, B: 2.0% or less and C: 2.0% or less.

The aforementioned Ti, V, Cr, Mn, Fe, Co, Ni, Zn, Al, B and C are optional elements.

As described above, a preferable upper limit of the Ti content is 2.0%. A further preferable upper limit of the Ti content is 1.0%, and more preferably is 0.5%. A preferable lower limit of the Ti content is 0.01%, more preferably is 0.05%, and further preferably is 0.1%.

As described above, a preferable upper limit of the V content is 2.0%. A more preferable upper limit of the V content is 1.0%, and further preferably is 0.5%. A preferable lower limit of the V content is 0.01%, more preferably is 0.05%, and further preferably is 0.1%.

As described above, a preferable upper limit of the Cr content is 2.0%. A more preferable upper limit of the Cr content is 1.0%, and further preferably is 0.5%. A preferable lower limit of the Cr content is 0.01%, more preferably is 0.05%, and further preferably is 0.1%.

As described above, a preferable upper limit of the Mn content is 2.0%. A more preferable upper limit of the Mn content is 1.0%, and further preferably is 0.5%. A preferable lower limit of the Mn content is 0.01%, more preferably is 0.05%, and further preferably is 0.1%.

As described above, a preferable upper limit of the Fe content is 2.0%. A more preferable upper limit of the Fe content is 1.0%, and further preferably is 0.5%. A preferable lower limit of the Fe content is 0.01%, more preferably is 0.05%, and further preferably is 0.1%.

As described above, a preferable upper limit of the Co content is 2.0%. A more preferable upper limit of the Co content is 1.0%, and further preferably is 0.5%. A preferable lower limit of the Co content is 0.01%, more preferably is 0.05%, and further preferably is 0.1%.

As described above, a preferable upper limit of the Ni content is 3.0%. A more preferable upper limit of the Ni content is 2.0%. A preferable lower limit of the Ni content is 0.1%.

As described above, a preferable upper limit of the Zn content is 3.0%. A more preferable upper limit of the Zn content is 2.0%. A preferable lower limit of the Zn content is 0.1%, more preferably is 0.5%, and further preferably is 1.0%.

As described above, a preferable upper limit of the Al content is 3.0%. A more preferable upper limit of the Al content is 2.0%, and further preferably is 1.0%. A preferable lower limit of the Al content is 0.1%, more preferably is 0.5%, and further preferably is 1.0%.

A preferable upper limit of the B content is 2.0%. A more preferable upper limit of the B content is 1.0%, and further preferably is 0.5%. A preferable lower limit of the B content is 0.01%, more preferably is 0.05%, and further preferably is 0.1%.

A preferable upper limit of the C content is 2.0%. A more preferable upper limit of the C content is 1.0%, and further preferably is 0.5%. A preferable lower limit of the C content is 0.01%, more preferably is 0.05%, and further preferably is 0.1%.

[Mean Particle Diameter of Specific Alloy]

It is preferable that the specific alloy is alloy particles (hereunder, also referred to as “specific alloy particles”) for which a mean particle diameter is in a range of 0.1 to 45 μm in terms of the median diameter. The particle diameter of the specific alloy particles influences the discharge capacity of the battery. The smaller that the particle diameter is, the more preferable. This is because, if the particle diameter is small, the total area of the negative electrode active material included in the negative electrode plate can be made large. Therefore, the mean particle diameter of the specific alloy particles is preferably a median diameter (D50) of not more than 45 μm. In this case, the reaction area of the particles increases. In addition, the occlusion of lithium as far as the inside of the particles as well as the discharge of lithium therefrom is facilitated. Consequently, it is easy to obtain sufficient discharge capacity. On the other hand, if the mean particle diameter is a median diameter (D50) of not less than 0.1 μm, the specific surface area of the particles will be sufficiently small, and it will be difficult for oxidation to occur. Therefore, in particular, the initial efficiency will increase. Accordingly, a preferable mean particle diameter of the specific alloy particles is, in terms of the median diameter (D50), in a range of 0.1 to 45 μm.

A preferable lower limit of the mean particle diameter (D50) is 0.4 μm, and more preferably is 1.0 μm. A preferable upper limit of the mean particle diameter (D50) is 40 μm, and more preferably is 35 μm.

The mean particle diameter can be measured as follows. In a case where the mean particle diameter is 0.5 μm or more in terms of the median diameter (D50), the mean particle diameter is determined by a gasflow-type high-speed dynamic image analysis method. An analyzer with the trade name Camsizer X manufactured by Verder Scientific Co., Ltd. is used for the analysis.

In a case where the mean particle diameter is less than 0.5 μm in terms of the median diameter (D50), the mean particle diameter is measured using a laser particle size distribution analyzer. A particle size distribution analyzer with the trade name “Microtrac particle size distribution analyzer” that is manufactured by Nikkiso Co., Ltd. is used as the laser particle size distribution analyzer.

[Material Other than Specific Alloy Contained in Negative Electrode Active Material]

The aforementioned negative electrode active material may contain a material other than the specific alloy. For example, in addition to the specific alloy, the negative electrode active material may contain graphite as an active material.

[Methods for Producing Negative Electrode Active Material and Negative Electrode]

Methods for producing the aforementioned negative electrode active material containing the specific alloy, and a negative electrode and a battery that use the negative electrode active material will now be described. The method for producing the negative electrode active material includes a process of preparing a molten metal (preparation process), and a process of rapidly cooling the molten metal to produce a thin metal strip (thin metal strip production process).

[Preparation Process]

In the preparation process, a molten metal having the aforementioned chemical composition is produced. The molten metal is produced by melting raw material by a well-known melting method such as arc melting or resistance heating melting. The molten metal temperature is preferably 800° C. or more.

Next, the molten metal is subjected to rapid solidification. In the course of solidification in which the molten metal is rapidly cooled and solidifies, the η′ phase, ε phase and Sn phase that are equilibrium phases form a refined solidification micro-structure, and this is brought to room temperature. Methods that adopt rapid solidification include a strip casting method and a melt-spinning method. In the present embodiment, the strip casting method is taken as one example and is described hereinafter.

[Thin Metal Strip Production Process]

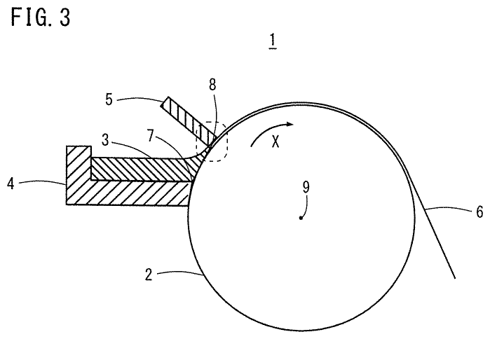

Thin metal strip 6 is produced using a production apparatus illustrated in FIG. 3. A production apparatus 1 includes a cooling roll 2, a tundish 4 and a blade member 5. The method for producing the negative electrode active material of the present embodiment is, for example, a strip casting (SC) method that includes the blade member 5.

[Cooling Roll]

The cooling roll 2 has an outer peripheral surface, and cools and solidifies the molten metal 3 on the outer peripheral surface while rotating. The cooling roll 2 includes a cylindrical body portion and an unshown shaft portion. The body portion has the aforementioned outer peripheral surface. The shaft portion is disposed at a central axis position of the body portion, and is attached to an unshown driving source. The cooling roll 2 is driven by the driving source to rotate around a central axis 9 of the cooling roll 2.

The starting material of the cooling roll 2 is preferably a material with high hardness and high thermal conductivity. The starting material of the cooling roll 2 is, for example, copper or a copper alloy. Preferably, the starting material of the cooling roll 2 is copper. The cooling roll 2 may also have a coating on the surface thereof. By this means, the hardness of the cooling roll 2 increases. The coating is, for example, a plating coating or a cermet coating. The plating coating is, for example, chrome plating or nickel plating. The cermet coating contains, for example, one or more types selected from a group consisting of tungsten (W), cobalt (Co), titanium (Ti), chromium (Cr), nickel (Ni), silicon (Si), aluminum (Al), and boron (B) as well as carbides, nitrides and carbo-nitrides of these elements. Preferably, the outer layer of the cooling roll 2 is copper, and the cooling roll 2 also has a chrome plating coating on the surface thereof.

The character X shown in FIG. 3 denotes the rotational direction of the cooling roll 2. When producing the thin metal strip 6, the cooling roll 2 rotates in the fixed direction X. By this means, in the example illustrated in FIG. 3, a part of the molten metal 3 that contacts the cooling roll 2 is solidified on the outer peripheral surface of the cooling roll 2 and moves accompanying rotation of the cooling roll 2.

The peripheral speed of the cooling roll 2 is appropriately set in consideration of the cooling rate of the molten metal 3 and the efficiency of production. If the peripheral speed of the roll is slow, the efficiency of production decreases. If the peripheral speed of the roll is fast, the thin metal strip 6 is liable to peel off from the outer peripheral surface of the cooling roll 2. Consequently, the time period for which the thin metal strip 6 is in contact with the outer peripheral surface of the cooling roll 2 is shortened. In this case, the thin metal strip 6 is air-cooled without being subjected to heat dissipation by the cooling roll 2. In a case where the thin metal strip 6 is air-cooled, a sufficient cooling rate is not obtained. Consequently, in some cases a fine micro-structure is not obtained, and the island-like regions 10 and the reticulate regions 20 are not obtained and/or the average size of the island-like regions 10 is more than 900 nm. Accordingly, a lower limit of the peripheral speed of the roll is preferably 50 m/min, more preferably is 80 m/min, and further preferably is 120 m/min. Although an upper limit of the peripheral speed of the roll is not particularly limited, in consideration of the equipment capacity the upper limit is, for example, 500 m/min. The peripheral speed of the roll can be determined based on the diameter and number of rotations of the roll.

A solvent for heat dissipation may be filled inside the cooling roll 2. By this means, the molten metal 3 can be efficiently cooled. The solvent is, for example, one or more types selected from a group consisting of water, organic solvents and oil. The solvent may be retained inside the cooling roll 2 or may be circulated with the exterior thereof.

[Tundish]

The tundish 4 is capable of receiving the molten metal 3, and supplies the molten metal 3 onto the outer peripheral surface of the cooling roll 2.

The shape of the tundish 4 is not particularly limited as long as it is capable of supplying the molten metal 3 onto the outer peripheral surface of the cooling roll 2. The shape of the tundish 4 may be a box shape in which the upper part is open as illustrated in FIG. 3, or may be another shape.

The tundish 4 includes a feed end 7 that guides the molten metal 3 onto the outer peripheral surface of the cooling roll 2. After the molten metal 3 is supplied to the tundish 4 from an unshown crucible, the molten metal 3 is supplied onto the outer peripheral surface of the cooling roll 2 by way of the feed end 7. The shape of the feed end 7 is not particularly limited. A cross-section of the feed end 7 may be a rectangular shape as illustrated in FIG. 3, or may be a shape that has an inclination. Alternatively, the feed end 7 may be a nozzle shape.

Preferably, the tundish 4 is disposed in the vicinity of the outer peripheral surface of the cooling roll 2. By this means the molten metal 3 can be stably supplied onto the outer peripheral surface of the cooling roll 2. A gap between the tundish 4 and the cooling roll 2 is appropriately set within a range such that the molten metal 3 does not leak.

The starting material of the tundish 4 is preferably a refractory material. The tundish 4, for example, contains one or more types of element selected from a group consisting of aluminum oxide (Al₂O₃), silicon monoxide (SiO), silicon dioxide (SiO₂), chromium oxide (Cr₂O₃), magnesium oxide (MgO), titanium oxide (TiO₂), aluminum titanate (Al₂TiO₅) and zirconium oxide (ZrO₂).

[Blade Member]

The blade member 5 is disposed on the downstream side in the rotational direction of the cooling roll 2 relative to the tundish 4, in a manner so that a gap is provided between the blade member 5 and the outer peripheral surface of the cooling roll 2. The blade member 5, for example, is a plate-like member disposed parallel to the axial direction of the cooling roll 2.

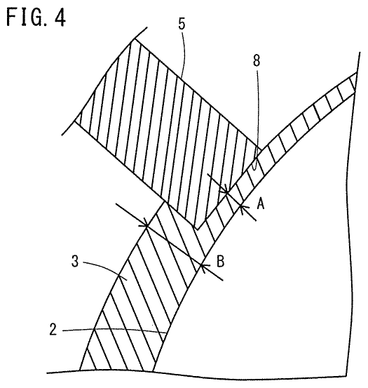

FIG. 4 is a cross-sectional view illustrating, in an enlarged manner, the vicinity of the front end (area enclosed by a dashed line in FIG. 3) of the blade member 5 of the production apparatus 1. Referring to FIG. 4, the blade member 5 is disposed in a manner in which a gap A is provided between the blade member 5 and the outer peripheral surface of the cooling roll 2. The blade member 5 regulates the thickness of the molten metal 3 on the outer peripheral surface of the cooling roll 2 so as to be a thickness corresponding to the width of the gap A between the outer peripheral surface of the cooling roll 2 and the blade member 5. Specifically, in some cases the molten metal 3 that is further upstream in the rotational direction of the cooling roll 2 than the blade member 5 is thicker than the width of the gap A. In such a case, the molten metal 3 of an amount corresponding to a thickness that is more than the width of the gap A is held back by the blade member 5. By this means, the thickness of the molten metal 3 is thinned to the width of the gap A. The cooling rate of the molten metal 3 increases as a result of the thickness of the molten metal 3 becoming thinner. Consequently, the micro-structure is refined. By this means, a specific alloy phase can be finely formed.

The width of the gap A is preferably narrower than a thickness B of the molten metal 3 on the outer peripheral surface on the upstream side in the rotational direction of the cooling roll 2 relative to the blade member 5. In this case, the molten metal 3 on the outer peripheral surface of the cooling roll 2 becomes thinner. Therefore, the cooling rate of the molten metal 3 increases further. As a result, the micro-structure is refined. By this means, a specific alloy phase can be finely formed.

The width of the gap A between the outer peripheral surface of the cooling roll 2 and the blade member 5 is the shortest distance between the blade member 5 and the outer peripheral surface of the cooling roll 2. The width of the gap A is appropriately set in accordance with the intended cooling rate and efficiency of production. The narrower that the width of the gap A is, the thinner that the molten metal 3 becomes after thickness adjustment. Therefore, the narrower that the gap A is, the more that the cooling rate of the molten metal 3 will increase. As a result, it will be easier to make the micro-structure finer. Accordingly, the upper limit of the gap A is preferably 100 μm, and more preferably is 50 μm.

On the outer peripheral surface of the cooling roll 2, the distance between a location at which the molten metal 3 is supplied from the tundish 4 and a location at which the blade member 5 is disposed is set as appropriate. It suffices that the blade member 5 is disposed in an area within which the free surface of the molten metal 3 (surface on the side on which the molten metal 3 does not contact the cooling roll 2) comes in contact with the blade member 5 in a liquid or semisolid state.

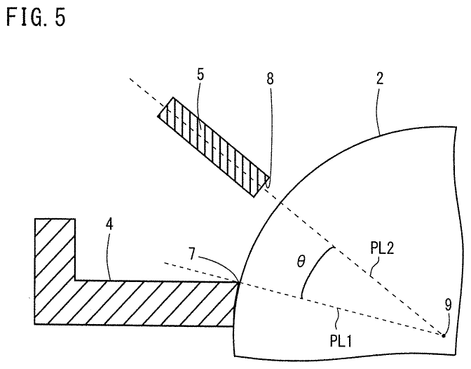

FIG. 5 is a view illustrating a mounting angle of the blade member 5. Referring to FIG. 5, for example the blade member 5 is disposed so that an angle θ formed by a plane PL1 that includes the central axis 9 of the cooling roll 2 and the feed end 7 and a plane PL2 that includes the central axis 9 of the cooling roll 2 and the front end portion of the blade member 5 is constant (hereunder, this angle θ is referred to as “mounting angle θ”). The mounting angle θ can be set as appropriate. The upper limit of the mounting angle θ is, for example, 45°. The upper limit of the mounting angle θ is preferably 30°. Although the lower limit of the mounting angle θ is not particularly limited, the lower limit is preferably within a range such that the blade member 5 does not directly contact the molten metal 3 on the tundish 4.

Referring to FIG. 3 to FIG. 5, preferably the blade member 5 has a heat dissipation face 8. The heat dissipation face 8 is disposed facing the outer peripheral surface of the cooling roll 2. The heat dissipation face 8 contacts the molten metal 3 that passes through the gap between the outer peripheral surface of the cooling roll 2 and the blade member 5.

The starting material of the blade member 5 is preferably a refractory material.

The blade member 5, for example, contains one or more types of element selected from a group consisting of aluminum oxide (Al₂O₃), silicon monoxide (SiO), silicon dioxide (SiO₂), chromium oxide (Cr₂O₃), magnesium oxide (MgO), titanium oxide (TiO₂), aluminum titanate (Al₂TiO₅) and zirconium oxide (ZrO₂). Preferably, the blade member 5 contains one or more types of element selected from a group consisting of aluminum oxide (Al₂O₃), silicon dioxide (SiO₂), aluminum titanate (Al₂TiO₅) and magnesium oxide (MgO).

A plurality of blade members 5 may be disposed consecutively with respect to the rotational direction of the cooling roll 2. In this case, the load applied to a single blade member 5 decreases. In addition, the accuracy with respect to the thickness of the molten metal 3 can be enhanced.

In the production apparatus 1 described above, the thickness of the molten metal 3 on the outer peripheral surface of the cooling roll 2 is regulated by the blade member 5. Therefore, the molten metal 3 on the outer peripheral surface of the cooling roll 2 becomes thin. Because the molten metal 3 becomes thin, the cooling rate of the molten metal 3 increases. Therefore, by using the production apparatus 1 to produce thin metal strips, the thin metal strip 6 having more refined specific alloy phases can be produced. In the case of using the production apparatus 1 described above, a preferable average cooling rate is 100° C./sec or more. The average cooling rate in this case is calculated by the following equation.

Average cooling rate=(molten metal temperature−temperature of thin metal strip when rapid cooling ends)/rapid cooling time period

In a case where the thin metal strip 6 is produced by an apparatus that does not include the blade member 5, that is, when strip casting (SC) is performed by the conventional method, the thickness of the molten metal 3 on the outer peripheral surface of the cooling roll 2 cannot be regulated to a thin thickness. In this case, the cooling rate of the molten metal 3 decreases. Therefore, even if an MG treatment that is described later is executed, the thin metal strip 6 having a fine micro-structure is not obtained. That is, the island-like regions 10 and the reticulate regions 20 are not obtained, and/or the average size of the island-like regions 10 is more than 900 nm.

In addition, in a case where the thin metal strip 6 is produced by an apparatus that does not include the blade member 5, it is necessary to make the peripheral speed of the cooling roll 2 fast in order to reduce the thickness of the molten metal 3 on the outer peripheral surface of the cooling roll 2. If the peripheral speed of the roll is fast, the thin metal strip 6 will quickly peel off from the outer peripheral surface of the cooling roll 2. That is, a time period for which the thin metal strip 6 contacts the outer peripheral surface of the cooling roll 2 will shorten. In this case, the thin metal strip 6 will not be subjected to heat dissipation by the cooling roll 2, and will be air-cooled. In a case where the thin metal strip 6 is air-cooled, a sufficient average cooling rate is not obtained. Consequently, the thin metal strip 6 having a fine micro-structure is not obtained. That is, the island-like regions 10 and the reticulate regions 20 are not obtained, and/or the average size of the island-like regions 10 is more than 900 nm.

[MG Treatment Process]

A mechanical grinding (MG) treatment may be performed on the thin metal strip 6 that was produced using the production apparatus 1. By this means, the mean particle diameter (D50) of the specific alloy produced by the rapid solidification process can be further reduced.

The mechanical grinding (MG) treatment includes the following processes. First, the specific thin metal strip is inserted together with balls in an MG device such as an attritor or a vibratory ball mill. An addition agent for preventing granulation may also be inserted in the MG device together with the balls.

Next, a process of subjecting the specific thin metal strip inside the MG device to pulverization with high energy, and a process of compression-bonding together the specific alloy particles formed by the pulverization are repeated. By this means, specific alloy particles having, in terms of the median diameter, a mean particle diameter (D50) in a range of 0.1 to 45 μm are produced.

The MG device is, for example, a high-speed planetary mill. An example of a high-speed planetary mill is a high-speed planetary mill with the trade name “High G BX” that is manufactured by Kurimoto Ltd. Preferable production conditions for the MG device are as follows.

Ball ratio: 5 to 80

The term “ball ratio” refers to the mass ratio with respect to the specific thin metal strip that serves as the raw material, and is defined by the following equation.

Ball ratio=ball mass/specific thin metal strip mass

A preferable ball ratio is in a range of 5 to 80. A more preferable lower limit of the ball ratio is 10, and more preferably is 12. A more preferable upper limit of the ball ratio is 60, and more preferably is 40.

Note that, for example, SUJ2 defined in JIS Standard is used as the starting material for the balls. The diameter of the balls is, for example, from 0.8 mm to 10 mm.

MG treatment time: 1 to 48 hours

A preferable MG treatment time is in the range of 1 to 48 hours. A preferable lower limit of the MG treatment time is 2 hours, and more preferably is 4 hours. A preferable upper limit of the MG treatment time is 36 hours, and more preferably is 24 hours. Note that, a unit stopping time which is described later is not included in the MG treatment time.

Cooling condition during MG treatment: stop for 30 minutes or more per 3 hours of MG treatment (intermittent operation)

If the temperature of the specific alloy becomes too high during the MG treatment, the mean particle diameter will be large. A preferable temperature of the chiller cooling water of the device during MG treatment is in a range of 1 to 25° C.

In addition, the total stopping time per 3 hours of MG treatment (hereinafter, referred to as “unit stopping time”) is set to be not less than 30 minutes. In a case where the MG treatment is performed continuously, even if the chiller cooling water is adjusted to within the aforementioned range, the temperature of the specific alloy will be too high and the alloy particles will be large. If the unit stopping time is not less than 30 minutes, the occurrence of a situation in which the temperature of the specific alloy becomes excessively high can be suppressed, and enlargement of the mean particle diameter can also be suppressed.

In the aforementioned MG treatment, polyvinyl pyrrolidone (PVP) can be added as an addition agent for preventing granulation. A preferable added amount of PVP is in a range of 0.5 to 8 mass % with respect to the mass of the specific thin metal strip (raw material), and more preferably is in a range of 2 to 5 mass %. If the added amount of PVP is in the aforementioned range, it is easy to adjust the mean particle diameter of the specific alloy to within an appropriate range, and adjustment of the mean particle diameter of the specific alloy particles to within a range of 0.1 to 45 μm in terms of the median diameter (D50) is facilitated. However, in the MG treatment, the mean particle diameter (D50) of the specific alloy can be adjusted even if the addition agent is not added.

The specific alloy is produced by the above processes. Another active material (graphite) may be mixed with the specific alloy as necessary. A negative electrode active material is produced by the above processes. The negative electrode active material may be a material composed of the specific alloy and impurities, or may contain the specific alloy and another active material (for example, graphite).

[Method for Producing Negative Electrode]

A negative electrode that uses the negative electrode active material according to the present embodiment can be produced, for example, by the following well-known method.

A binder such as polyvinylidene fluoride (PVDF), polymethyl methacrylate (PMMA), polytetrafluoroethylene (PTFE) or styrene-butadiene rubber (SBR) is mixed with the aforementioned negative electrode active material to produce a mixture. Furthermore, to impart sufficient conductivity to the negative electrode, carbon material powder such as natural graphite, artificial graphite or acetylene black is mixed in the aforementioned mixture to produce a negative electrode compound. After dissolving the binder by adding a solvent such as N-methylpyrrolidone (NMP), dimethylformamide (DMF) or water, the negative electrode compound is sufficiently agitated using a homogenizer or glass beads if necessary to thereby form the negative electrode compound into a slurry. The slurry is applied onto a support body such as rolled copper foil or an electrodeposited copper foil and is dried. Thereafter, the dried product is subjected to pressing. A negative electrode is produced by the above processes.

From the viewpoint of the mechanical strength and battery characteristics of the negative electrode, the amount of the binder to be admixed is preferably in a range of 1 to 10 mass % relative to the amount of the negative electrode compound. The support body is not limited to a copper foil. The support body may be, for example, a thin foil of another metal such as stainless steel or nickel, a net-like sheet punching plate, or a mesh braided with a metal element wire or the like.

[Method for Producing Battery]

A nonaqueous electrolyte secondary battery according to the present embodiment includes the negative electrode as described above, a positive electrode, a separator, and an electrolytic solution or electrolyte. The shape of the battery may be cylindrical or a square shape, or may be a coin shape or a sheet shape or the like.

The battery of the present embodiment may also be a battery that utilizes a solid electrolyte, such as a polymer battery.

The positive electrode of the battery of the present embodiment preferably contains a lithium (Li)-containing transition-metal compound as the active material. The Li-containing transition-metal compound is, for example, LiM₁₋ₓM′ₓO₂ or LiM₂yM′O₄. Where, in the chemical Formulae, 0≤x, y≤1, and M and M′ are respectively at least one type of element selected from barium (Ba), cobalt (Co), nickel (Ni), manganese (Mn), chromium (Cr), titanium (Ti), vanadium (V), iron (Fe), zinc (Zn), aluminum (Al), indium (In), tin (Sn), scandium (Sc) and yttrium (Y).

The battery of the present embodiment may use other positive electrode materials such as a transition metal chalcogenide; vanadium oxide and a lithium (Li) compound thereof; niobium oxide and a lithium compound thereof; a conjugated polymer that uses an organic conductive substance; a Chevrel-phase compound; activated carbon; or an activated carbon fiber.

The electrolytic solution of the battery of the present embodiment is generally a nonaqueous electrolytic solution in which lithium salt as the supporting electrolyte is dissolved into an organic solvent. Examples of the lithium salt include LiClO₄, LiBF₄, LiPF₆, LiAsF₆, LiB(C₆H₅), LiCF₃SO₃, LiCH₃SO₃, Li(CF₃SO₂)₂N, LiC₄F₉SO₃, Li(CF₂SO₂)₂, LiCl, LiBr, and LiI. These lithium salts may be used singly or in a combination of two types of more.

The organic solvent is preferably a carbonic ester such as propylene carbonate, ethylene carbonate, ethyl methyl carbonate, dimethyl carbonate or diethyl carbonate. However, other various kinds of organic solvents including carboxylate ester and ether are usable. These organic solvents may be used singly or in a combination of two types or more.

The separator is disposed between the positive electrode and the negative electrode. The separator serves as an insulator. Further, the separator greatly contributes to retention of the electrolyte. The battery of the present embodiment may include a well-known separator. The separator is made of, for example, polypropylene or polyethylene, which are polyolefin-based materials, or a mixed fabric of the two materials, or is a porous body such as a glass filter.

The above described negative electrode, positive electrode, separator, and electrolytic solution or electrolyte are enclosed in a container for a battery, to thereby produce a battery.

Hereinafter, the negative electrode active material, the negative electrode, and the battery of the present embodiment described above will be described in more detail using examples. Note that the negative electrode active material, the negative electrode, and the battery of the present embodiment are not limited to the examples described below.

### EXAMPLES

Metallic particles, negative electrode active materials, negative electrodes and coin batteries of Test Nos. 1 to 32 shown in Table 1 were produced. Changes in the X-ray profiles caused by charging and discharging of the metallic particles of the respective Test Nos. were checked, and the crystal structures (formed phases) were identified. In addition, the initial discharge capacity of the battery (discharge capacity per volume), the discharge capacity at the time of 100 cycles, and the capacity retention ratio were investigated.

TABLE 1

| | Chemical Composition | Melted Raw Material (g) | | | |
|---|---|---|---|---|---|
| Test No. | (metallic particles) | Cu | Sn | Si | Other |
| 1 | Cu-12.0 at % Sn-14.0 at | 721.2 | 218.5 | 60.3 | — |
| | % Si | | | | |
| 2 | Cu-14.0 at % Sn-16.0 at | 678.2 | 253.3 | 68.5 | — |
| | % Si | | | | |
| 3 | Cu-14.0 at % Sn-12.0 at | 701.7 | 248.0 | 50.3 | — |
| | % Si | | | | |
| 4 | Cu-15.0 at % Sn-16.0 at | 662.9 | 269.2 | 67.9 | — |
| | % Si | | | | |
| 5 | Cu-16.0 at % Sn-14.0 at | 659.9 | 281.7 | 58.3 | — |
| | % Si | | | | |
| 6 | Cu-18.0 at % Sn-12.0 at | 642.6 | 308.7 | 48.7 | — |
| | % Si | | | | |
| 7 | Cu-20.0 at % Sn-16.0 at | 590.2 | 344.5 | 65.2 | — |
| | % Si | | | | |
| 8 | Cu-22.0 at % Sn-11.0 at | 593.2 | 363.8 | 43.0 | — |
| | % Si | | | | |
| 9 | Cu-22.0 at % Sn-22.5 at | 520.9 | 385.7 | 93.4 | — |
| | % Si | | | | |
| 10 | Cu-10.5 at % Sn-22.5 at | 693.9 | 203.1 | 103.0 | — |
| | % Si | | | | |
| 11 | Cu-10.5 at % Sn-11.0 at | 762.3 | 190.5 | 47.2 | — |
| | % Si | | | | |
| 12 | Cu-14.0 at % Sn-16.0 at | 670.1 | 253.9 | 68.7 | Ti: 7.3 |
| | % Si-1.0 at % Ti | | | | |
| 13 | Cu-14.0 at % Sn-16.0 at | 669.8 | 253.8 | 68.6 | V: 7.78 |
| | % Si-1.0 at % V | | | | |
| 14 | Cu-14.0 at % Sn-16.0 at | 669.6 | 253.8 | 68.6 | Cr: 7.94 |
| | % Si-1.0 at % Cr | | | | |
| 15 | Cu-14.0 at % Sn-16.0 at | 669.3 | 253.7 | 68.6 | Mn: 8.39 |
| | % Si-1.0 at % Mn | | | | |
| 16 | Cu-14.0 at % Sn-16.0 at | 669.2 | 253.6 | 68.6 | Fe: 8.52 |
| | % Si-1.0 at % Fe | | | | |
| 17 | Cu-14.0 at % Sn-16.0 at | 668.9 | 253.5 | 68.6 | Co: 8.99 |
| | % Si-1.0 at % Co | | | | |
| 18 | Cu-14.0 at % Sn-16.0 at | 659.8 | 253.7 | 68.6 | Ni: 17.92 |
| | % Si-2.0 at % Ni | | | | |
| 19 | Cu-14.0 at % Sn-16.0 at | 658.4 | 253.2 | 68.5 | Zn: 19.93 |
| | % Si-2.0 at % Zn | | | | |
| 20 | Cu-14.0 at % Sn-16.0 at | 666.2 | 256.2 | 69.3 | Al: 8.32 |
| | % Si-2.0 at % Al | | | | |
| 21 | Cu-14.0 at % Sn-16.0 at | 673.9 | 255.4 | 69.1 | B: 1.66 |
| | % Si-1.0 at % B | | | | |
| 22 | Cu-14.0 at % Sn-16.0 at | 673.8 | 255.3 | 69.1 | C: 1.85 |
| | % Si-1.0 at % C | | | | |
| 23 | 100 at % Si | — | — | 1000.0 | — |
| 24 | Cu-35.0 at % Sn-2.0 at | 487.4 | 505.8 | 6.8 | — |
| | % Si | | | | |
| 25 | Cu-35.0 at % Sn-30.0 at | 308.0 | 575.3 | 116.7 | — |
| | % Si | | | | |
| 26 | Cu-2.0 at % Sn-30.0 at | 800.0 | 44.0 | 156.0 | — |
| | % Si | | | | |
| 27 | Cu-2.0 at % Sn-2.0 at | 954.1 | 37.1 | 8.8 | — |
| | % Si | | | | |
| 28 | Cu-17.0 at % Sn-23.0 at | 588.7 | 311.5 | 99.7 | — |
| | % Si | | | | |
| 29 | Cu-17.0 at % Sn-30.0 at | 540.7 | 324.0 | 135.3 | — |
| | % Si | | | | |
| 30 | Cu-2.0 at % Sn-17.0 at | 878.0 | 40.5 | 81.5 | — |
| | % Si | | | | |
| 31 | Cu-2.0 at % Sn-11.0 at | 910.1 | 39.1 | 50.9 | — |
| | % Si | | | | |
| 32 | Cu-35.0 at % Sn-22.5 at | 360.7 | 554.9 | 84.4 | — |
| | % Si | | | | |

The methods for producing the metallic particles, negative electrode active material, negative electrode and coin battery of each Test No. were as follows.

[Production of Metallic Particles]

Referring to Table 1, molten metal was produced so that the chemical compositions of powdered metallic particles other than the metallic particles of Test No. 23 became the chemical compositions shown in Table 1. For example, in the case of Test No. 1, molten metal was produced so that the chemical composition of the powdered metallic particles contained Cu-12.0% Sn-14.0% Si, that is, 12.0% of Sn and 14.0% of Si, with the balance being Cu and impurities. The molten metal was produced by subjecting a raw material containing the metals (unit is g) shown in the “melted raw material” column in Table 1 to high-frequency melting.

Note that, other than in Test No. 23 in which a powder reagent of pure Si as a negative electrode active material was pulverized using an automatic mortar and used as alloy particles, the methods for producing the negative electrode active material, negative electrode, coin battery and laminated cell battery were as follows.

With respect to the molten metal of the Test Nos. other than Test No. 2C, after stabilizing the molten metal temperature at 1200° C., a thin metal strip was cast under the solidification and cooling conditions described in Table 2. The conditions of the respective solidification and cooling methods are as follows.

TABLE 2

| | | | | Average Size | Mean Particle |
|---|---|---|---|---|---|
| | | | | of Island-like | Diameter |
| | Solidification | | Main Formed | Regions (nm) | (D50) (μm) |
| Test | and Cooling | MG | Phases (after | (after | (after |
| No. | Method Condition | Treatment | pulverization) | pulverization) | pulverization) |
| 1 | SC Condition 1 | No | η′, Sn | 384 | 27.6 |
| 2A | SC Condition 1 | No | η′, Sn | 276 | 23.7 |
| 2B | SC Condition 1 | Yes | η′, Sn | 276 | 2.3 |
| 2C | Ingot Smelting | No | η′, Sn | 8930 | 43.6 |
| 2D | SC Condition 1 | No | η′, Sn | 276 | 152.0 |
| 2E | SC Condition 2 | No | η′, Sn | 1256 | 21.6 |
| 2F | SC Condition 3 | No | η′, Sn | 2347 | 35.7 |
| 3 | SC Condition 1 | No | η′, Sn | 451 | 32.4 |
| 4 | SC Condition 1 | No | η′, Sn | 287 | 21.9 |
| 5 | SC Condition 1 | No | η′, Sn | 296 | 25.6 |
| 6 | SC Condition 1 | No | η′, Sn | 302 | 23.9 |
| 7 | SC Condition 1 | No | η′, Sn, ε | 341 | 27.4 |
| 8 | SC Condition 1 | No | η′, Sn, ε | 337 | 26.8 |
| 9 | SC Condition 1 | No | η′, Sn, ε | 325 | 21.6 |
| 10 | SC Condition 1 | No | η′, Sn | 438 | 36.9 |
| 11 | SC Condition 1 | No | η′, Sn | 401 | 31.6 |
| 12 | SC Condition 1 | No | η′, Sn | 286 | 24.7 |
| 13 | SC Condition 1 | No | η′, Sn | 263 | 26.5 |
| 14 | SC Condition 1 | No | η′, Sn | 289 | 24.9 |
| 15 | SC Condition 1 | No | η′, Sn | 304 | 23.1 |
| 16 | SC Condition 1 | No | η′, Sn | 317 | 27.0 |
| 17 | SC Condition 1 | No | η′, Sn | 298 | 24.9 |
| 18 | SC Condition 1 | No | η′, Sn | 270 | 21.9 |
| 19 | SC Condition 1 | No | η′, Sn | 264 | 23.4 |
| 20 | SC Condition 1 | No | η′, Sn | 307 | 27.6 |
| 21 | SC Condition 1 | No | η′, Sn | 312 | 21.9 |
| 22 | SC Condition 1 | No | η′, Sn | 298 | 24.1 |
| 23 | — | No | Si phase | — | 15.0 |
| 24 | SC Condition 1 | No | ε, η′ | 9730 | 41.3 |
| 25 | SC Condition 1 | No | Unidentified other | — | 36.7 |
| | | | phases | | |
| 26 | SC Condition 1 | No | Cu—Si compound phase | — | 40.6 |
| 27 | SC Condition 1 | No | Cu (solid solution) | — | 41.7 |
| 28 | SC Condition 1 | No | ε | 396 | 20.3 |
| 29 | SC Condition 1 | No | Unidentified other | — | 35.4 |
| | | | phases | | |
| 30 | SC Condition 1 | No | Cu (solid solution) and | — | 39.3 |
| | | | unidentified other phases | | |
| 31 | SC Condition 1 | No | Cu (solid solution) and | — | 40.3 |
| | | | unidentified other phases | | |
| 32 | SC Condition 1 | No | η′, Sn | 8570 | 36.3 |

[SC Condition 1]

According to SC condition 1, strip casting (SC) in which the raised thickness of the molten metal was regulated using the blade member as described in the aforementioned embodiment was performed. According to this SC, the molten metal was rapidly cooled, and a thin metal strip having a thickness of 70 μm cast. Specifically, a water-cooled cooling roll made of copper was used. The rotational speed of the cooling roll was set as 300 meters per minute with respect to the circumferential speed of the roll surface. In an argon atmosphere, the aforementioned molten metal was supplied onto the rotating water-cooled roll through a horizontal tundish (made of alumina). The molten metal was raised on the rotating water-cooled roll such that the molten metal was subjected to rapid solidification. The width of the gap between the blade member and the water-cooled roll was 70 μm. The blade member was made of alumina.

[SC Condition 2]

According to SC condition 2, SC was performed without using a blade member. That is, according to SC condition 2, a thin metal strip was produced by a conventional SC method. According to this SC method, molten metal was rapidly cooled, and a thin metal strip having a thickness of 40 μm was cast. Specifically, a water-cooled cooling roll made of copper was used. The rotational speed of the cooling roll was set as 600 meters per minute with respect to the circumferential speed of the roll surface. In an argon atmosphere, the aforementioned molten metal was supplied onto the rotating water-cooled roll through a horizontal tundish (made of alumina). The molten metal was raised on the rotating water-cooled roll such that the molten metal was subjected to rapid solidification.

[SC Condition 3]

According to SC condition 3, SC was performed without using a blade member. That is, according to SC condition 3, a thin metal strip was produced by a conventional SC method. According to this SC method, molten metal was rapidly cooled, and a thin metal strip having a thickness of 200 μm was cast. Specifically, a water-cooled cooling roll made of copper was used. The rotational speed of the cooling roll was set as 70 meters per minute with respect to the circumferential speed of the roll surface. In an argon atmosphere, the aforementioned molten metal was supplied onto the rotating water-cooled roll through a horizontal tundish (made of alumina). The molten metal was raised on the rotating water-cooled roll such that the molten metal was subjected to rapid solidification.

With respect to the molten metal of Test No. 2C, after the molten metal temperature was stabilized at 1200° C., an alloy ingot was cast.

[Production of Metallic Particles by Pulverization Treatment]

A pulverization treatment using a mixer mill was performed on the thin metal strips produced in the Test Nos. other than Test No. 2D, and on the ingot of Test No. 2C. Specifically, the respective thin metal strips were subjected to a pulverization treatment using a mixer mill (apparatus model name: MM400) manufactured by Verder Scientific Co., Ltd. A container made of stainless steel that had an internal volume of 25 cm³ was used as the pulverizing container. Two balls made of the same material as the pulverizing container and having a diameter of 15 mm as well as 3 g of a rapidly-cooled foil ribbon or ingot were placed in the pulverizing container, the setting value for the vibration frequency was 25 rps, and the mixer mill was operated for 600 seconds to produce metallic particles.

For Test No. 2D, the produced thin metal strip was subjected to a pulverization treatment using a mixer mill. Specifically, the thin metal strip was subjected to a pulverization treatment using a mixer mill (apparatus model name: MM400) manufactured by Verder Scientific Co., Ltd. A container made of stainless steel that had an internal volume of 25 cm³ was used as the pulverizing container. One ball made of the same material as the pulverizing container and having a diameter of 10 mm as well as 3 g of a rapidly-cooled foil ribbon were placed in the pulverizing container, the setting value for the vibration frequency was 25 rps, and the mixer mill was operated for 30 seconds to produce metallic particles.

[Production of Metallic Particles by MG Treatment]

After the pulverization treatment, the metallic particles of Test No. 2B were further subjected to an MG treatment. Specifically, a thin metal strip, graphite powder (mean particle diameter of 5 μm in terms of median diameter (D50)), and PVP were mixed at a ratio of 90:6:4. The mixture was subjected to an MG treatment using a high-speed planetary mill (trade name “High G BX”, manufactured by Kurimoto Ltd) in an argon gas atmosphere. The “MG conditions” were as follows.
Rotational speed: 200 rpm (equivalent to centrifugal acceleration of 12 G)
Ball ratio: 15 (thin metal strip material: balls=40 g: 600 g)
PVP: 4 mass %
MG treatment time period: 12 hours

The MG treatment was performed while cooling with a chiller. The temperature of the cooling water of the chiller was 10° C.

For Test No. 23, a pure silicon bulk material was prepared as the raw material. The bulk material was pulverized using a mixer mill to produce Si powder particles. The mean particle diameter (D50) (median diameter) of the Si powder particles was 15.0 μm. The produced Si powder particles were adopted as the metallic particles for Test No. 23.

Metallic particles that were negative electrode active materials were produced by the foregoing processes.

[Identification of Crystal Structure (Formed Phases) of Metallic Particles, Measurement of Average Size of Island-Like Regions 10, and Measurement of Mean Particle Diameter (D50)]

The produced metallic particles were subjected to processes in which the crystal structure (formed phases) was identified, the average size of the island-like regions 10 was measured, and the mean particle diameter (D50) was measured.

[Identification of Crystal Structure (Formed Phases)]

The metallic particles in a state after pulverization and prior to MG treatment were subjected to X-ray diffraction measurement, and measured data of the X-ray diffraction profiles was obtained. Specifically, SmartLab (rotor target maximum output 9 KW; 45 kV-200 mA) manufactured by Rigaku Co., Ltd. was used to obtain X-ray diffraction profiles of the powder of the negative electrode active materials. The constituent phases of the metallic particles were identified based on the obtained X-ray diffraction profiles (measured data). The X-ray diffraction apparatus and measurement conditions were as follows.

[X-Ray Diffraction Apparatus Name and Measurement Conditions]
Apparatus: SmartLab manufactured by Rigaku Co., Ltd.
X-ray tube: Cu-Kα ray
X-ray output: 45 kV, 200 mA
Incident monochromator: Johannson type crystal (which filters out Cu-Kα₂ ray and Cu-Kβ ray)
Optical system: Bragg-Brentano geometry
Incident parallel slit: 5.0 degrees
Incident slit: ½ degree
Length limiting slit: 10.0 mm
Receiving slit 1: 8.0 mm
Receiving slit 2: 13.0 mm
Receiving parallel slit: 5.0 degrees
Goniometer: SmartLab goniometer
X-ray source—mirror distance: 90.0 mm
X-ray source—selection slit distance: 114.0 mm
X-ray source—sample distance: 300.0 mm
Sample—receiving slit 1 distance: 187.0 mm
Sample—receiving slit 2 distance: 300.0 mm
Receiving slit 1—receiving slit 2 distance: 113.0 mm
Sample—detector distance: 331.0 mm
Detector: D/Tex Ultra
Measurement range: 10 to 120 degrees
Data acquisition angle interval: 0.02 degrees
Scan method: continuous
Scanning speed: 0.1 degrees/min

The method of analyzing the crystal structure is described hereunder taking analysis of the metallic particles of Test No. 2A as an example.

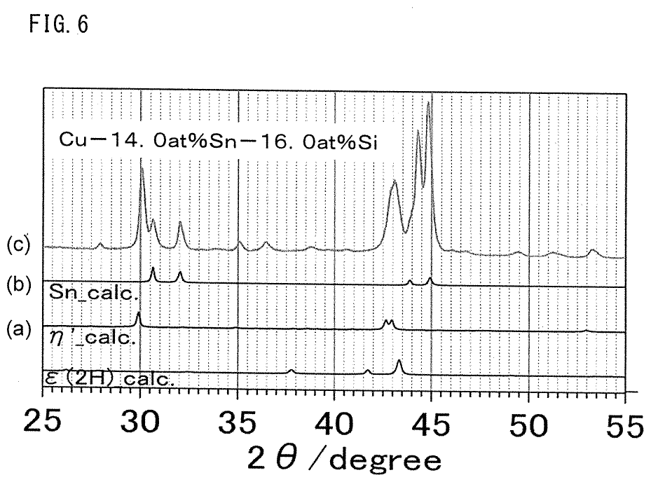

FIG. 6 is a view illustrating a powder X-ray diffraction profile and phase identification results for Test No. 2A. In FIG. 6, (a) and (b) denote diffraction lines for the η′ phase and Sn single phase, respectively. Referring to FIG. 6, diffraction peaks of a measured X-ray diffraction profile ((c) in the figure) mainly match the peaks of the diffraction lines of(a) and (b). Therefore, it was identified that the metallic particles (negative electrode active material) of Test No. 2A included the η′ phase and Sn phase. Apart from these phases, as illustrated in FIG. 6, the formation of other phases that were unidentified was also confirmed. The crystal structures of the respective negative electrode active materials (metallic particles) of the other Test Nos. were also identified by a similar method (shown in Table 2). In Table 2, “η′”, “Sn” and “c” in the “main formed phases” column denote the η′ phase, Sn phase, and ε phase, respectively.

[Measurement of Average Size of Island-Like Regions 10]

The average size of the island-like regions 10 was determined by the method described above using a scanning electron microscope having the product model number “SU 9000” manufactured by Hitachi High-Technologies Corporation. The obtained results are shown in Table 2.

[Measurement of mean particle diameter (D50) of metallic particles]

The powder particle size distribution of the metallic particles (Test Nos. 1, 2A, 2C, 2D, 2E, 2F and 3 to 27) that were produced by only a pulverization treatment and without undergoing an MG treatment was measured by a gasflow-type high-speed dynamic image analysis method using an analyzer having the trade name Camsizer X manufactured by Verder Scientific Co., Ltd. The mean particle diameter (D50) was determined based on the measurement results. The obtained results are shown in Table 2.

On the other hand, the powder particle size distribution of the metallic particles (Test No. 2B) that were produced by performing an MG treatment after performing a pulverization treatment was measured using a laser particle size distribution analyzer (“Microtrac particle size distribution analyzer” manufactured by Nikkiso Co., Ltd.). The mean particle diameter (D50) was determined based on the measured powder particle size distribution. The obtained result is shown in Table 2.

[Production of Negative Electrode for Coin Battery]

For each Test No., a negative electrode compound slurry containing the negative electrode active material was produced using the aforementioned metallic particles as the negative electrode active material. Specifically, the powdered metallic particles, acetylene black (AB) as a conductive additive, styrene-butadiene rubber (SBR) as a binder (2-fold dilution), and carboxymethyl cellulose (CMC) as a thickening agent were mixed in a mass ratio of 75:15:10:5 (blending quantity was 1 g:0.2 g:0.134 g:0.067 g) to produce a mixture. Thereafter, a kneading machine was used to produce a negative electrode compound slurry by adding distilled water to the mixture such that the slurry density was 27.2%. Since the styrene-butadiene rubber was used by being diluted 2-fold with water, 0.134 g of styrene-butadiene rubber was blended when weighing.

The produced negative electrode compound slurry was applied onto a copper foil using an applicator (150 μm). The copper foil on which the slurry was applied was dried at 100° C. for 20 minutes. The copper foil after drying had a coating film composed of the negative electrode active material on the surface. The copper foil having the negative electrode active material film was subjected to punching to produce a disc-shaped copper foil having a diameter of 13 mm. The copper foil after punching was pressed at a press pressure of 500 kgf/cm² to produce a plate-shaped negative electrode.

[Production of Coin Battery]

The produced negative electrode, EC-DMC-EMC-VC-FEC as the electrolytic solution, a polyolefin separator (q 17 mm) as the separator, and a metal Li plate (φ 19×1 mmt) as the positive electrode material were prepared. The thus-prepared negative electrode material, electrolytic solution, separator, and positive electrode material were used to produce a 2016 type coin battery. Assembly of the coin battery was performed within a glove box in argon atmosphere.

[Evaluation of Charge-Discharge Characteristics of Coin Battery]

The discharge capacity and cycle characteristics of the battery of each Test No. were evaluated by the following method.

Constant current doping (corresponding to insertion of lithium ions into an electrode, and charging of a lithium ion secondary battery) was performed with respect to the coin battery at a current value of 0.1 mA (a current value of 0.075 mA/cm²) or a current value of 1.0 mA (a current value of 0.75 mA/cm²) until the potential difference with respect to the counter electrode became 0.005 V. Thereafter, doping was continued with respect to the counter electrode at a constant voltage until the current value became 7.5 μA/cm² while retaining 0.005 V.

Next, the de-doping capacity was measured by performing de-doping (corresponding to desorption of lithium ions from the electrode, and discharge of the lithium ion secondary battery) at a current value of 0.1 mA (a current value of 0.075 mA/cm²) or a current value of 1.0 mA (a current value of 0.75 mA/cm²) until the potential difference became 1.2 V.

The doping capacity and de-doping capacity correspond to charge capacity and discharge capacity when the electrode is used as the negative electrode of the lithium ion secondary battery. Therefore, the measured de-doping capacity was defined as “discharge capacity”. Charging and discharging of the coin battery were repeated. The doping capacity and de-doping capacity were measured each time charging and discharging were performed in each cycle. The measurement results were used to obtain the charge-discharge cycle characteristics. Specifically, the discharge capacity (mAh/cm³) for the first (initial) cycle was determined.

In addition, the discharge capacity (mAh/cm³) and the capacity retention ratio after 100 cycles were determined. The capacity retention ratio is a numerical value shown as a percentage that was obtained by dividing the discharge capacity after 100 cycles by the initial discharge capacity.

The capacity of the coin battery was calculated as a value that was obtained by deducting the capacity of the conductive additive (acetylene black: AB), which is then divided by the fraction of alloy in the negative electrode compound to convert to the capacity of the elemental alloy. For example, in a case where the ratio in the negative electrode compound was alloy: conductive additive (AB): binder (SBR solid content): CMC=75:15:5:5, after converting the measured charge capacity or discharge capacity to a value per 1 g of the negative electrode compound, the capacitive component of acetylene black (25 mAh/g) was deducted, and the resulting value was multiplied by 6/5 to convert to the capacity of the elemental alloy negative electrode based on the mixture ratio (alloy: AB+binder+CMC=75:25) and thereby calculate the capacity of the coin battery.

The results are shown in Table 3.

TABLE 3

Coin Battery Characteristics

| | Initial Discharge | Discharge Capacity | Capacity |
|---|---|---|---|
| Test | Capacity | at 100 Cycles | Retention |
| No. | (mAh/cm³) | (mAh/cm³) | Ratio (%) |
| 1 | 1404 | 1334 | 95 |
| 2A | 2180 | 1890 | 87 |
| 2B | 3284 | 3011 | 92 |
| 2C | 2387 | 640 | 27 |
| 2D | 1310 | 851 | 65 |
| 2E | 2163 | 973 | 45 |
| 2F | 2283 | 731 | 32 |
| 3 | 1568 | 1448 | 92 |
| 4 | 2106 | 1841 | 87 |
| 5 | 1997 | 1724 | 86 |
| 6 | 1927 | 1648 | 86 |
| 7 | 2768 | 2240 | 81 |
| 8 | 2690 | 2435 | 91 |
| 9 | 3416 | 2839 | 83 |
| 10 | 2270 | 1981 | 87 |
| 11 | 1184 | 1128 | 95 |
| 12 | 2223 | 1864 | 84 |
| 13 | 2192 | 1919 | 88 |
| 14 | 2168 | 1841 | 85 |
| 15 | 2145 | 1778 | 83 |
| 16 | 2215 | 1919 | 87 |
| 17 | 2270 | 2153 | 95 |
| 18 | 2168 | 1786 | 82 |
| 19 | 2324 | 1927 | 83 |
| 20 | 2285 | 2051 | 90 |
| 21 | 2114 | 1895 | 90 |
| 22 | 2153 | 2044 | 95 |
| 23 | 2395 | 326 | 14 |
| 24 | 3674 | 836 | 23 |
| 25 | 3370 | 979 | 29 |
| 26 | 847 | 707 | 83 |
| 27 | 187 | 170 | 91 |
| 28 | 1874 | 1518 | 81 |
| 29 | 3297 | 989 | 30 |
| 30 | 169 | 155 | 92 |
| 31 | 80 | 65 | 81 |
| 32 | 3421 | 236 | 7 |

[Measurement Results]

Referring to Table 1 to Table 3, the chemical compositions of the metallic particles of Test Nos. 1, 2A, 2B, 2D, 3 to 22 and 28 were appropriate, and included at least one type of phase among the η′ phase, ε phase and Sn phase. Note that, in each Test No., formation of other phases that were unidentified was also confirmed. In addition, the average size of the island-like regions 10 in the micro-structure was not more than 900 nm. As a result, the discharge capacity was higher than the theoretical capacity of graphite (833 mAh/cm³) with respect to both the initial discharge capacity and the discharge capacity after 100 cycles. Further, the capacity retention ratio was 50% or more in each case.

On the other hand, in Test No. 2C, although the chemical composition was appropriate and the metallic particles included the η′ phase and ε phase, because the ingot was pulverized in a mixer mill the average size of the island-like regions 10 in the micro-structure was more than 900 nm. As a result, the discharge capacity after 100 cycles was lower than the theoretical capacity of graphite. In addition, the capacity retention ratio was a low value of less than 50%.

In Test No. 2E, although the chemical composition was appropriate and the metallic particles included the η′ phase and ε phase, the average size of the island-like regions 10 in the micro-structure was more than 900 nm. As a result, the capacity retention ratio was a low value of less than 50%. In the case of Test No. 2E, it is considered that because SC in which a blade member was not used was performed and furthermore the peripheral speed of the roll was too fast, sufficient rapid cooling could not be performed and hence the average size of the island-like regions 10 in the micro-structure was more than 900 nm.

In Test No. 2F, although the chemical composition was appropriate and the metallic particles included the η′ phase and ε phase, the average size of the island-like regions 10 in the micro-structure was more than 900 nm. As a result, the discharge capacity after 100 cycles was lower than the theoretical capacity of graphite. In addition, the capacity retention ratio was a low value of less than 50%. In the case of Test No. 2F, it is considered that because SC in which a blade member was not used was performed and, furthermore, the peripheral speed of the roll was too fast, the thin metal strip was too thick and hence the average size of the island-like regions 10 in the micro-structure was more than 900 nm.

In Test No. 23, Si was used as the negative electrode active material. As a result, the discharge capacity after 100 cycles was 326 mAh/cm³, and the capacity retention ratio was a remarkably low value of 14%. It is considered that because Si was used as the negative electrode active material, the volumetric expansion and contraction at the time of occlusion and discharge of lithium ions was too large, and consequently the capacity retention ratio was low.

In Test Nos. 24 to 27, 29 and 30 to 32, the chemical composition was not appropriate. Therefore, the crystal structures of these metallic particles either did not contain any phase among the η′ phase, ε phase and Sn phase, or the average size of the island-like regions 10 in the micro-structure was more than 900 nm.

Specifically, in Test No. 24, although the η′ phase and ε phase were the main constituents, the average size of the island-like regions 10 in the micro-structure was more than 900 nm. As a result, the capacity retention ratio was a low value that was less than 50%. It is considered that this was because the Si content percentage was small, and hence the ε phase and η′ phase that are Cu—Sn binary system equilibrium phases formed a coarse composite micro-structure.

In Test No. 25, unidentified other phases were the main constituents. As a result, the capacity retention ratio was a low value that was less than 50%.

In Test No. 26, a Cu—Si compound phase was the main constituent. As a result, the discharge capacity was lower than the theoretical capacity of graphite.

The crystal structure of the metallic particles of Test No. 27 was estimated to be a solid solution of Cu. Consequently, the discharge capacity was lower than the theoretical capacity of graphite.

In Test No. 29, unidentified other phases were the main constituents. As a result, the capacity retention ratio was a low value that was less than 50%.

The crystal structure of the metallic particles of Test No. 30 was estimated as having a solid solution of Cu and unidentified other phases as the main constituents. Consequently, the discharge capacity was lower than the theoretical capacity of graphite.

The crystal structure of the metallic particles of Test No. 31 was estimated as having a solid solution of Cu and unidentified other phases as the main constituents. Consequently, the discharge capacity was lower than the theoretical capacity of graphite.

In Test No. 32, although the η′ phase and Sn phase were the main constituents of the crystal structure of the metallic particles, the average size of the island-like regions 10 in the micro-structure was more than 900 nm. As a result, the capacity retention ratio was a low value that was less than 50%. It is considered that this was because the Sn content percentage was too high, and hence the Sn phase and the η′ phase that is a Cu—Sn binary system equilibrium phase formed a coarse composite micro-structure.

An embodiment of the present invention has been described above. However, the foregoing embodiment is merely an example for implementing the present invention. Accordingly, the present invention is not limited to the above embodiment, and the above embodiment can be appropriately modified within a range that does not deviate from the gist of the present invention.

1. A negative electrode active material, comprising:
an alloy having a chemical composition consisting of, in at %:
Sn: 10.0 to 22.5%, and
Si: 10.5 to 23.0%,
with the balance being Cu and impurities;
wherein:
in a Cu—Sn binary phase diagram,
the alloy has at least one type of phase among an η′ phase, an ε phase and a Sn phase,
and a micro-structure of the alloy has reticulate regions, and island-like regions that are surrounded by the reticulate regions,
in which an average size of the island-like regions is 900 nm or less in equivalent circular diameter.

2. The negative electrode active material according to claim 1, wherein the chemical composition further contains, in place of a part of Cu:
one or more types of element selected from a group consisting of Ti, V, Cr, Mn, Fe, Co, Ni, Zn, Al, B and C.

3. The negative electrode active material according to claim 2, wherein the chemical composition contains one or more types of element selected from a group consisting of:
Ti: 2.0% or less,
V: 2.0% or less,
Cr: 2.0% or less,
Mn: 2.0% or less,
Fe: 2.0% or less,
Co: 2.0% or less,
Ni: 3.0% or less,
Zn: 3.0% or less,
Al: 3.0% or less,
B: 2.0% or less, and
C: 2.0% or less.

4. The negative electrode active material according to claim 1, wherein
the alloy is alloy particles having a mean particle diameter that is, in terms of median diameter, in a range of 0.1 to 45 μm.

5-6. (canceled)

7. The negative electrode active material according to claim 2, wherein
the alloy is alloy particles having a mean particle diameter that is, in terms of median diameter, in a range of 0.1 to 45 μm.

8. The negative electrode active material according to claim 3, wherein
the alloy is alloy particles having a mean particle diameter that is, in terms of median diameter, in a range of 0.1 to 45 μm.

9. A negative electrode that comprises the negative electrode active material according to claim 1.

10. A negative electrode that comprises the negative electrode active material according to claim 2.

11. A negative electrode that comprises the negative electrode active material according to claim 3.

12. A negative electrode that comprises the negative electrode active material according to claim 4.

13. A negative electrode that comprises the negative electrode active material according to claim 7.

14. A negative electrode that comprises the negative electrode active material according to claim 8.

15. A battery that comprises the negative electrode according to claim 9.

16. A battery that comprises the negative electrode according to claim 10.

17. A battery that comprises the negative electrode according to claim 11.

18. A battery that comprises the negative electrode according to claim 12.

19. A battery that comprises the negative electrode according to claim 13.

20. A battery that comprises the negative electrode according to claim 14.
